(19) United States
(12) Patent Application Publication
(10) Pub. No.: US 2005/0192710 A1
(43) Pub. Date: Sep. 1, 2005

(54) Method and apparatus for validation of a wireless system installation

(75) Inventors: Dean C. Thornton, Lakeside, CA (US); George Seelman, Murrieta, CA (US)

Correspondence Address: John D. Bauersfeld;KELLY BAUERSFELD LOWRY & KELLE, LLP, Suite 1650, 6320 Canoga Avenue, Woodland Hills, CA, 91367, US

(73) Assignee: RAIN BIRD CORPORATION

(21) Appl. No.: 10/789,634

(22) Filed: Feb. 27, 2004

(51) Int. Cl. B05B 12/08

(52) U.S. Cl. 700/284

(57) ABSTRACT

Methods and apparatuses for testing the installation of sensors, irrigation system components and controllers are provided. An apparatus or sensor unit is for use with an irrigation system and comprises a processor and a sensor coupled to the processor and adapted to provide a sensor response. The sensor can be a water sensor, a temperature sensor, a humidity sensor, a ground moisture sensor, a solar radiation sensor, a wind speed sensor, or a water flow rate sensor, among others. A communication circuit is coupled to the processor which in turn can cause the communication circuit to transmit a first signal in response to the sensor response. The processor can further cause the communication circuit to transmit a test signal having a signal strength that is less than the strength of the first signal to simulate the deteriorated conditions that can be present during a transmission.

### FIELD OF THE INVENTION

This invention relates generally to the field of irrigation controllers and sensors and more particularly to a method and apparatus for testing the installation of wireless sensors and controllers.

### BACKGROUND

Automatic irrigation systems are used to irrigate lawns, crops, public parks, gardens, golf courses and other tracts of land having plants. These systems typically incorporate an irrigation controller that operates an irrigation program, i.e., that determines what days and times individual areas or stations are to be watered. An irrigation controller may include a microprocessor driven programmable device that retains program data and is capable of turning on and off individual stations or valves based upon program data resident within an electronic memory, such as for example, RAM.

Some of these systems operate on a fixed schedule where the operator sets the watering schedule for each station with the irrigation controller that provides the same irrigation run time(s) regardless of the season or weather. These controllers require the operator to make adjustments to the schedule to account for seasonal variations. Moreover, in order to conserve water while at the same time keeping the plants adequately maintained, it may be necessary to adjust station runtimes on a weekly or even daily basis. Since some irrigation controllers control a large number of individual stations and a property owner may have a large number of controllers, it may not be feasible to perform detailed adjustments to stations on a regular basis via manual means.

Therefore, some irrigation controllers communicate with sensors that can detect rainfall and cause the controllers to suspend irrigation until the rain has stopped. In other instances the rain shut off is manual, and the controllers often include a rain delay button to allow for suspension of irrigation when rain is present or imminent.

Some controllers communicate with sensors that can detect moisture in the soil and suspend irrigation while the detected moisture is above a given threshold. Other controllers use numerous external sensors to take measurements of other environmental conditions such as humidity, precipitation, temperature, and wind to calculate the landscape irrigation use. These systems can offer the best irrigation savings, but the cost and maintenance of the sensors can be high.

In some instances, irrigation controller and sensor systems have included wireless links that allow the user to remotely position a sensor device or a component control device at a location distant from the controller without having to provide a wiring path for communication with the controller. However, once the wireless sensor or component control device is installed, it is susceptible to changing environmental conditions that may affect its communication path to the irrigation controller. Cloud cover, foliage growth and the installation of man-made objects or structures can interfere with this wireless communication.

Once a wireless sensor or component control device has been installed, it usually is desirable to test it. For example, it may be desirable to verify that transmitter and receiver units can communicate successfully at the installed distance and that the communication link will continue to be good if conditions affecting the transmission deteriorate. Testing the transmission by manually operating the sensor or component controller may not test for deteriorated conditions and can require that one person be at the transmitter and another be at the receiver. Therefore improvements are needed to these wireless systems in order to help overcome such problems.

### SUMMARY OF THE ILLUSTRATED EMBODIMENTS

A wireless system comprising one or more transmitting devices and one or more receiving devices is provided. During installation of the system, the user can activate a test signal to be sent from the transmitting device to the receiving device in order to determine if the specific installation location will result in a reliable communication path when various types of interference are encountered in the future. According to one embodiment of the invention, the user initiates a test signal by depressing a pin or button mounted on the transmitting device. This will cause the transmitting device to send a test signal at approximately one half of the normal transmitting signal strength. If the receiving device successfully receives the signal, the user is notified by light emitting diodes (LED) or other indicators located either on the receiving or transmitting device.

In one aspect, an apparatus or sensor unit is for use with an irrigation system. The apparatus comprises a processor and a sensor coupled to the processor and adapted to provide a sensor response. The sensor can be a water sensor, a temperature sensor, a humidity sensor, a ground moisture sensor, a solar radiation sensor, a wind speed sensor, a water flow rate sensor, or other environmental or irrigation system condition sensors. A sensor response may include any of the following that arises as the result of the detection or measurement of that which the sensor is designed to detect or measure: the closing or opening of an electrical contact, the generation of an electrical signal, or the termination of an electrical signal.

A communication circuit is coupled to the processor which in turn can cause the communication circuit to transmit a first signal in response to the sensor response. The processor can further cause the communication circuit to transmit a second signal having a signal strength that is less than the strength of the first signal.

In another aspect, the sensor is comprised of an electrical contact that can be actuated, and the sensor response is the actuation of the electrical contact. The apparatus further includes a user input device for inputting a command wherein the input device is coupled to the processor and adapted to also actuate the electrical contact. The second signal is transmitted in response to the command from the input device. The user input device can be a button, a touch screen, a voice-activated device, or a menu structure shown on a display panel that is navigated by a keypad.

In another aspect, the electrical contact has a first position and a second position, wherein the contact is moved from the first position to the second position when the contact is actuated. The processor causes the communication circuit to transmit the second signal when the electrical contact is in the second position for a predetermined period of time.

In an alternative embodiment, the apparatus is for use with a second apparatus that is adapted to receive the first and second signals. The first apparatus further has an indicator coupled to the processor and adapted to provide a notification of any of the following events: the transmitting of the second signal, the receipt of the second signal by the second apparatus, or the sensor response corresponding to a predetermined value. The indicator may be a sound generation device, a panel adapted to display text, or a LED.

In another aspect, the apparatus further has a memory that is coupled to the processor. The memory stores an identity code corresponding to the identity of the apparatus. The first signal includes the identity code for use in verifying the authenticity of the signal.

In yet another embodiment, a first apparatus is for use with a second apparatus and for use with an irrigation system having an irrigation system controller adapted to operate an irrigation program. The second apparatus has a sensor adapted to provide a sensor response and has a communication circuit adapted to transmit a first signal in response to the sensor response and to transmit a second signal. The first signal has a first signal strength and the second signal has a second signal strength that is less than the first signal strength. The first apparatus comprises a processor coupled to the irrigation system controller and an indicator coupled to the processor. A communication circuit is coupled to the processor and is adapted to receive the first signal and the second signal. The processor is adapted to cause the irrigation system controller to terminate the irrigation program when the communication circuit receives the first signal and to cause the indicator to activate when the communication circuit receives the second signal.

In one aspect, the first apparatus further comprises a relay circuit coupled to the processor and to the irrigation system controller wherein the processor is adapted to cause the irrigation system controller to terminate the irrigation program by actuating the relay circuit when the communication circuit receives the first signal.

In yet another embodiment, a method of testing the wireless communication between a first apparatus and a second apparatus is disclosed. The first and second apparatuses are for use in an irrigation system. The first apparatus has a sensor that is adapted to provide a sensor response and is placed at a location that is spaced apart from the second apparatus. A user input device is used to input a command. A first signal is transmitted with a communication circuit in response to the command. The communication circuit includes a transmitter or a transceiver, and can transmit a second signal in response to the sensor response. The second signal has a greater signal strength than the first signal.

In one aspect, the first signal strength is between 20% and 80% of the second signal strength. In another aspect, the first signal strength is between 40% and 60% of the second signal strength.

In yet another embodiment, the apparatus comprises means for providing a first response as a function of an environmental condition. The apparatus further includes means for transmitting a first signal having a first signal strength and a second signal having a second signal strength that is less than the first signal strength. A processor is coupled to the providing means and the transmitting means. Program logic is executed by the processor and comprises means for causing the transmitting means to transmit the first signal in response to the first response, and to transmit the second signal.

In another embodiment, a first apparatus is for use with an irrigation system having an irrigation controller that is adapted to provide a control signal. The first apparatus comprises a processor coupled to the irrigation controller and adapted to process the control signal. The first apparatus further comprises a communication circuit coupled to the processor. The processor is adapted to cause the communication circuit to transmit a first signal having a first signal strength in response to the control signal. The processor is further adapted to cause the communication to transmit a second signal having a second signal strength that is less than the first signal strength.

In one aspect, the first apparatus is for use with a second apparatus that is adapted to receive the first and second signals. The first apparatus further comprises an indicator coupled to the processor and adapted to provide a notification of at least one event of the group consisting of: the transmitting of the second signal by the communication circuit and the receipt of the second signal by the second apparatus.

In yet another embodiment, the first apparatus for use with a second apparatus and for use with an irrigation system having an irrigation controller adapted to provide a control signal for the actuation of a valve. The second apparatus is coupled to the irrigation controller. Also, the second apparatus has a communication circuit that is adapted to transmit a first signal having a first signal strength in response to the control signal and to transmit a second signal having a second signal strength that is less than the first signal strength. The first apparatus comprises a processor coupled to the valve and an indicator coupled to the processor. A communication circuit is coupled to the processor and adapted to receive the first signal and the second signal. The processor is adapted to cause the valve to actuate when the communication circuit receives the first signal. The processor is further adapted to cause the indicator to activate when the communication circuit receives the second signal.

In one aspect, the first apparatus further comprises a contact coupled to the processor and coupled to the valve. The processor is adapted to cause the valve to actuate by actuating the contact when the communication circuit receives the first signal.

There are additional aspects to the present inventions. It should therefore be understood that the preceding is merely a brief summary of some their embodiments and aspects. Additional embodiments and aspects of the present inventions are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

FIG. 1 is a perspective view of a controller interface unit in accordance with one embodiment of the invention.

FIG. 2 is a perspective view of a sensor unit in accordance with an embodiment of the invention.

FIG. 3 is a front plan view of the controller interface unit of FIG. 1 connected to an irrigation controller.

FIG. 4 is a perspective view of the sensor unit of FIG. 2 being tested.

FIG. 5a is a simplified block diagram of a rain/temperature sensor unit in accordance with an embodiment of the present invention.

FIG. 5b is a simplified block diagram of a rain/temperature sensor unit in accordance with another embodiment of the present invention.

FIG. 5c is a simplified block diagram of a ground moisture sensor unit in accordance with another embodiment of the present invention.

FIG. 6a is a simplified block diagram of a controller interface unit in accordance with an embodiment of the invention.

FIG. 6b is a simplified block diagram of a controller interface unit in accordance with another embodiment of the invention.

FIG. 7 is a block diagram of a controller interface unit connected to an irrigation controller in accordance with another embodiment of the present invention.

FIG. 8 is a block diagram of a valve interface unit connected to a valve in accordance with another embodiment of the present invention.

FIG. 9a is a simplified block diagram of a controller interface unit in accordance with an embodiment of the present invention.

FIG. 9b is a simplified block diagram of a controller interface unit in accordance with another embodiment of the present invention.

FIG. 10a is a simplified block diagram of a valve interface unit in accordance with an embodiment of the present invention.

FIG. 10b is a simplified block diagram of a valve interface unit in accordance with another embodiment of the present invention.

### DETAILED DESCRIPTION OF THE PREFERRED EMBODIMENTS

In the following description, reference is made to the accompanying drawings that illustrate, by way of example only, several embodiments of the present invention. It is understood that other embodiments may be utilized and structural and operational changes may be made without departing from the scope of the present invention.

A wireless system comprising one or more transmitting devices and one or more receiving devices is provided. During installation of the system, the user can activate a test signal to be sent from the transmitting device to the receiving device in order to determine if the specific installation location will result in a reliable communication path when various types of interference are encountered in the future. According to one embodiment of the invention, the user initiates a test signal by depressing a pin or button mounted on the transmitting device. This will cause the transmitting device to send a test signal at about half of the normal transmitting signal strength. If the receiving device successfully receives the signal, the user is notified by light emitting diodes (LEDs) or other indicators located either on the receiving or transmitting device.

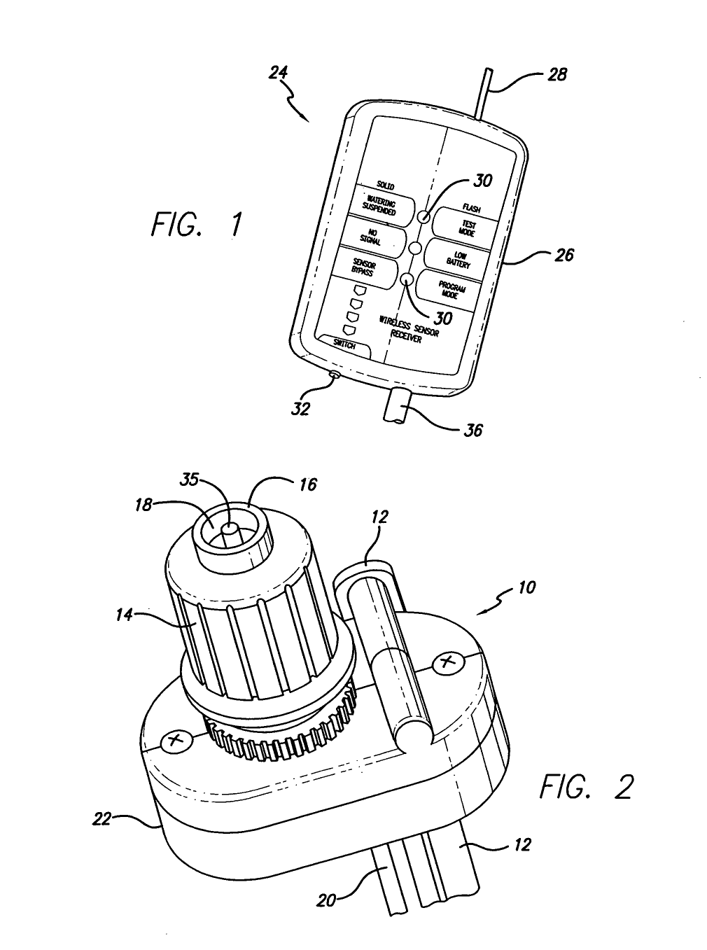

Referring to FIGS. 1-4, the transmitting device is a rain/temperature sensor 10 having a housing 22 attached to a hinged bracket 12 for mounting on an object, such as for example, a fence, post, roof of a house or other structure. Disposed on the housing 22 is a cap 14 with a hollow, open-ended cylinder 16 extending axially from the cap 14. The cylinder 16 has an upper opening 18 that is adapted to permit rainwater to enter the opening 18 and flow into the interior of the cap 14.

When rainwater enters the cap 14, it comes into contact with a hygroscopic material (not shown) disposed within the cap 14. When wet with a sufficient amount of moisture that is associated with a pre-determined quantity of rain, the hygroscopic material expands for a pre-determined distance thereby causing an actuator 35 to move downward and actuate a multi-function switch or contact (not shown) located within the cap 14.

The actuator 35 is comprised of a relatively flat circular plate (not shown) located within the cap 14 below the hygroscopic material. The actuator plate is disposed so that it abuts the contact and actuates it when the hygroscopic material expands for the pre-determined distance. The actuator 35 is further comprised of a post or pin (shown in FIG. 2) that extends upwardly from the circular plate axially within the cylinder 16 so that the end of the post can be manually pushed. The multi-function contact is in electrical communication with other circuitry located inside the housing 22. Upon sensing that the switch or contact has been actuated (i.e., a normally-open contact having been closed, or alternatively, a normally-closed contact having been opened) for a predetermined period of time, such as for example for 20 seconds or more, the circuitry causes a communication circuit to emit a radio frequency (RF) signal having a full or normal signal strength via an external antenna 20.

The actuator 35 can be used for testing the rain sensor signal during periods when it is not raining. By manually pressing the actuator 35, the same multi-function switch that actuates in response to the expansion of the hygroscopic material can be manually actuated. In alternative embodiments however, separate switches may be used. When manually depressed (FIG. 4), the actuator 35 causes the switch to actuate, and this also is detected by the system electronics. When the actuator 35 is depressed (and the switch actuated) for a relatively short period of time, such as for example, for less than 20 seconds, and then released, the circuitry will cause the communication circuit to emit a test signal at a reduced signal strength. On the other hand, if the actuator 35 is depressed for a time in excess of 20 seconds, then it is assumed that this condition is due to a rainfall of a certain minimum quantity, and the system electronics will cause the communication circuit to send the regular signal having the normal or full signal strength. Under most circumstances, therefore, it would not be desirable to manually depress the actuator for the longer period of time.

The sensor 10 further includes a temperature sensor circuit (not shown in FIGS. 1-4). When the ambient temperature drops and approaches the freezing point of water, the temperature circuit “trips” and provides an output signal. This is detected by the system electronics thereby causing the communication circuit to emit the regular, full-strength signal.

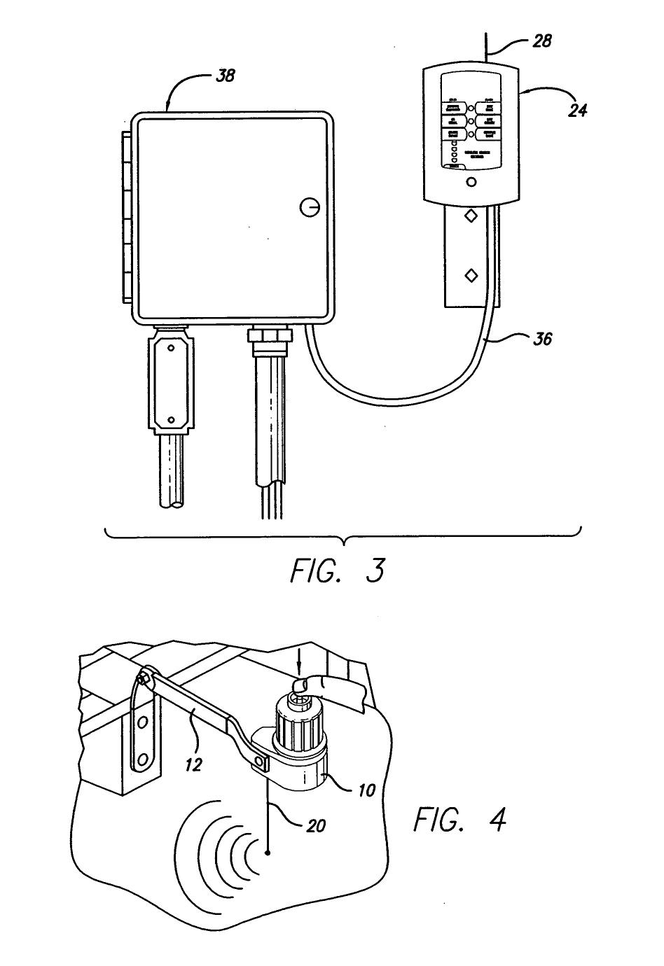

The signal is received by a controller interface unit 24 having a housing 26 and an external antenna 28 extending from the housing 26. The interface unit 24 has a plurality of LED indicators 30 mounted on the housing 26 and electrically connected to internal circuitry and a processor (not shown in FIGS. 1 and 3) located within the housing 26. A manual-operated, multifunction switch 32 extends from the housing 26 and is connected to the processor. A cable 36 electrically connects the interface unit 24 to an irrigation controller 38 that in turn provides electrical, radio frequency or other signals to irrigation system pumps and valves for turning irrigation water flow off and on according to a predetermined irrigation program. While the interface unit 24 of the illustrated embodiment is separate from the irrigation controller 38, alternative embodiments may include an interface unit that is integral with an irrigation controller and may be in the form of a permanent or removable module.

Thus in the embodiment of FIGS. 1-4, the sensor 10 and controller interface unit 24 act as an override that in effect supervises the operation of the controller 38. Without intervention of the interface unit 24, the controller 38 will perform the irrigation program or schedule as originally programmed. In the event of a rain of sufficient minimum quantity or a temperature below a predetermined threshold, the sensor 10 will send a normal signal to the interface unit 24. The interface unit 24 will analyze the signal and verify that it is authentic, i.e. that it originated from an authorized, or known, sensor or communication circuit. If the signal is verified, a contact located within the interface unit housing 26 will be actuated thus terminating or overriding the predetermined irrigation program that is established in the irrigation controller 38. During this override condition, the controller 38 will discontinue all irrigation activities as would be desirable for conservation of water during those times when it is raining, or during freezing temperature conditions.

As previously stated, it is sometimes desirable to test the wireless communication path between the sensor 10 and the controller interface unit 24. For example, this may be desirable during installation of the sensor 10 at a location that is remote from the interface unit 24. When signal testing is desired, the sensor actuator 35 is depressed for a predetermined period, such as for example 19 seconds or less, and then released. This causes the sensor electronics to send a test signal at a strength that is less than the normal signal strength. In the illustrated embodiment, the test signal strength is approximately one half of the normal signal strength. However alternative embodiments of the invention may include any test signal strength that is less than the normal signal strength, or alternatively, a test signal strength that is between about 20% and 80% of the normal signal strength, or alternatively still, a test signal strength that is between about 40% and 60% of the normal signal strength. Moreover, the test signal may include or may be encoded with information indicating that the signal identity is that of a test signal as opposed to a normal signal that is associated with the detection of precipitation or low temperatures or other sensor responses.

If the controller interface unit 24 successfully detects the test signal, the interface unit circuitry will read the information included within the signal to verify that the signal is authentic and is a test signal. If these conditions are met, the interface unit 24 will not actuate the interface unit contact which in turn will not override the controller irrigation schedule. Rather, the reception of an authentic test signal will cause the interface unit circuitry to energize or activate one of the LED's 30 on the interface unit housing 26 and maintain it in an energized condition for a predetermined period of time. This allows the user adequate time to travel from the location of the sensor 10 to the location of the interface unit 24 and observe the LED 30.

If the user sees that the LED is energized, then he or she will know that a communication link was successfully established. Given that a link was established with a test signal having a lower signal strength than that of a normal signal, there may be a higher level of assurance that a normal, full-strength signal will be received despite subsequently-arising interference conditions, such as changing foliage or weather, or the placement of new structures or objects in the communications path.

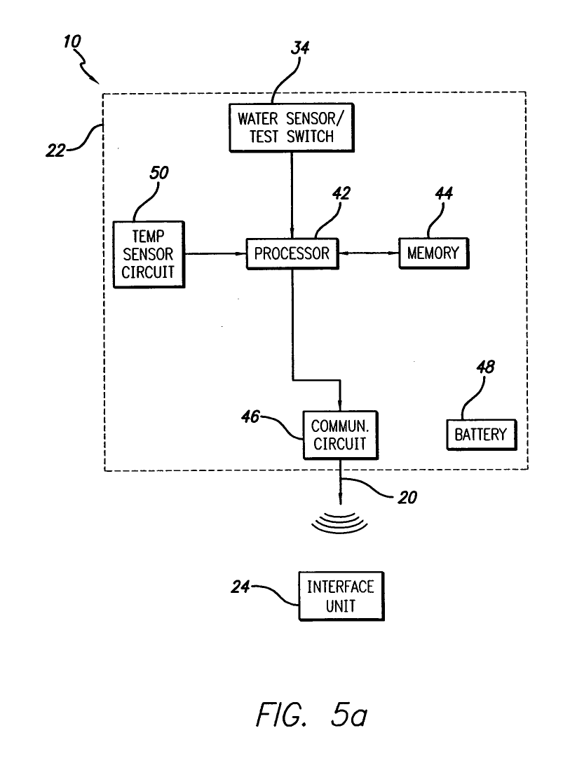

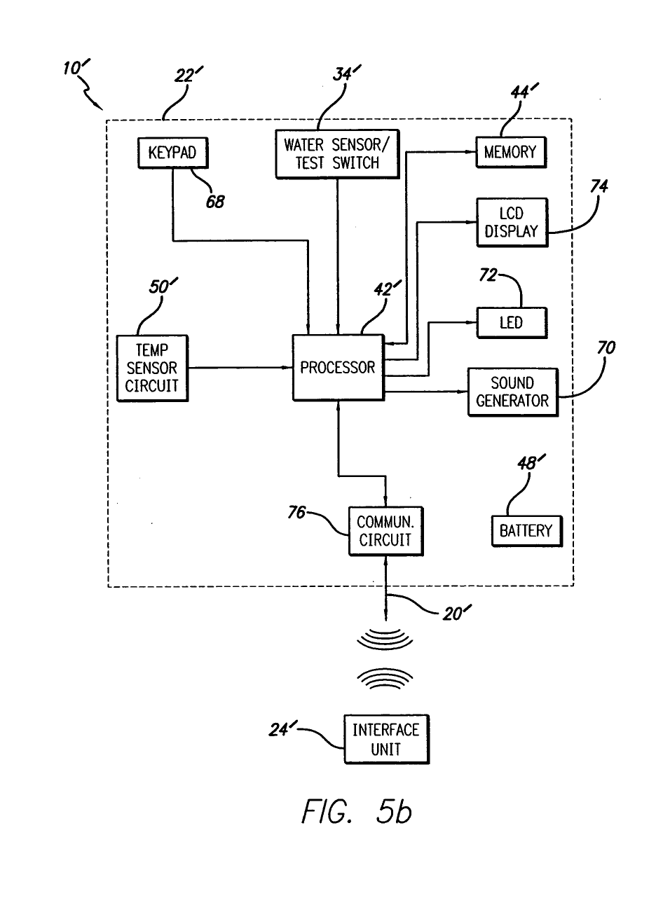

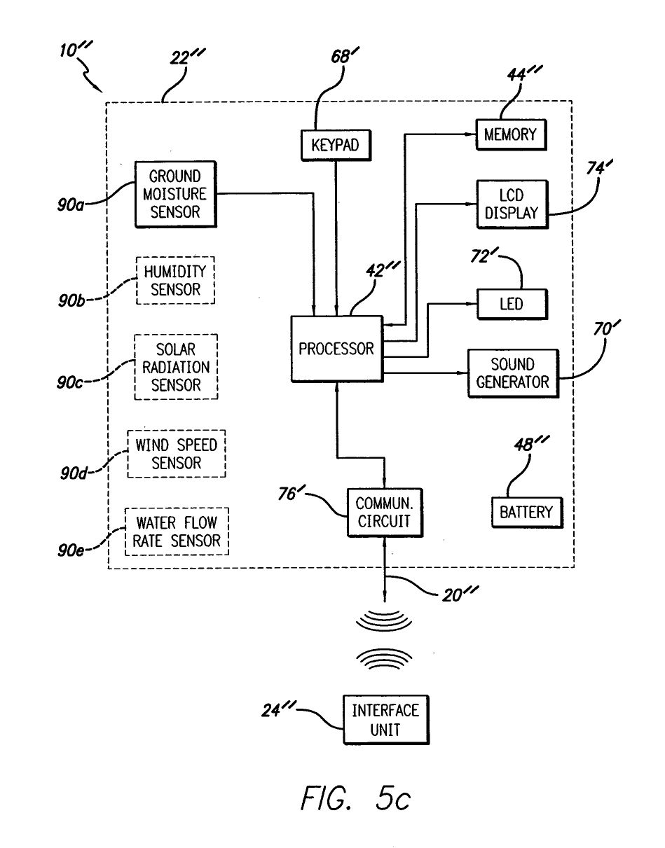

Referring now to FIG. 5a, the sensor 10 includes a multi-function, water sensor/test switch 34 that is adapted to provide a sensor response and that is coupled to a processor 42 which in turn executes programs and controls the sensor 10. The processor 42 is also connected to a memory device 44 for storing programs, data and parameters, including identity code or data corresponding to the identity of the sensor 10. Although FIG. 5a shows the memory 44 as a separate component, alternative embodiments may use a memory that is integral with the processor.

One of ordinary skill in the art will appreciate that the program logic described herein may be implemented in alternative embodiments in hardware, software, firmware, or a combination thereof. The program logic can be implemented in software or firmware that is stored in memory and that is executed by a processor. If implemented in hardware, the logic may be implemented in any one or combination of volatile memory devices (e.g., random access memory (RAM, such as DRAM, SRAM, SDRAM, etc.)) and nonvolatile memory devices (e.g., ROM, EPROM, hard drive, tape, CDROM, etc.).

Memory may incorporate electronic, magnetic, optical, and/or other types of storage media. Memory may also have a distributed architecture, where various components are situated remotely from one another. If implemented in hardware, the logic may be implemented with any or a combination of the following technologies, which are all known in the art: one or more discrete logic circuits for implementing logic functions upon data signals, an application specific integrated circuit (ASIC), a programmable gate array(s) (PGA), a field programmable gate array (FPGA), etc.

Once the switch 34 actuates, either due to the presence of a sufficient quantity of water or to the user pressing an actuator, the processor 42 detects this actuated condition and determines whether a predetermined amount of time has elapsed while the switch 34 remains actuated (i.e., while the switch remains closed in the case of a normally-open switch, or alternatively, while the switch remains opened in the case of a normally-closed switch). If the predetermined amount of time has elapsed, such as for example 20 seconds or more, then the processor 42 will cause a communication circuit 46 that includes a radio frequency (“RF”) transmitter to transmit a RF signal of full or normal strength that includes or is encoded with information containing the identity code associated with the sensor. Alternatively, the communication circuit 46 having the RF transmitter may be replaced with a communication circuit 76 having a RF transceiver (as shown in FIG. 5b) or 76′ (as shown in FIG. 5c), and the signal may be transmitted using the communication circuit 76 or 76′ having the RF transceiver.

On the other hand, if the switch 34 is actuated and remains actuated for another predetermined amount of time, such as for example 19 seconds or less, then the processor 42 causes the communication circuit 46 to transmit a RF signal having a signal strength that is less than normal strength and that includes information containing the identity code of the sensor 10 along with information indicating that the signal is a test signal. While the water sensor switch 34 provides a sensor response in the form of a “closed” or “open” condition of an electrical contact, alternative embodiments may include a sensor that provides other types of sensor responses, such as for example, a signal that varies with the amount of water detected. Moreover, while the illustrated embodiment discloses the transmission and receipt of RF signals, it will be appreciated by those skilled in the art that other wirelessly transmitted signals may be employed, such as for example infrared signals or ultrasonic signals.

Still referring to FIG. 5a, in addition to the water sensor/test switch 34 the sensor 10 further includes a temperature sensor circuit 50 that is coupled to the processor 42 and that provides a sensor response in accordance with a measurement of the ambient temperature. When the temperature reaches a predetermined, relatively cold temperature that approaches the freezing point of water, such as for example, 3° C., the temperature sensor circuit 50 sends a signal to the processor 42. The processor 42 reacts to this in the same or similar manner as if the water sensor/test switch 34 had closed for more than the predetermined amount of time. The processor 42 again causes the communication circuit 46 to transmit the same, full-strength signal for receipt by the interface unit 24.

Finally, the rain sensor 10 includes a power source, which in this embodiment is a battery 48. Alternative embodiments however may employ other power sources, such as, for example, a solar panel, a fuel cell or a power cable that is connected to an external power source. The battery 48 provides power to all components of the sensor circuitry, including the processor 42, the memory 44, the water sensor/test switch 34, the temperature circuit 50, and the communication circuit 46.

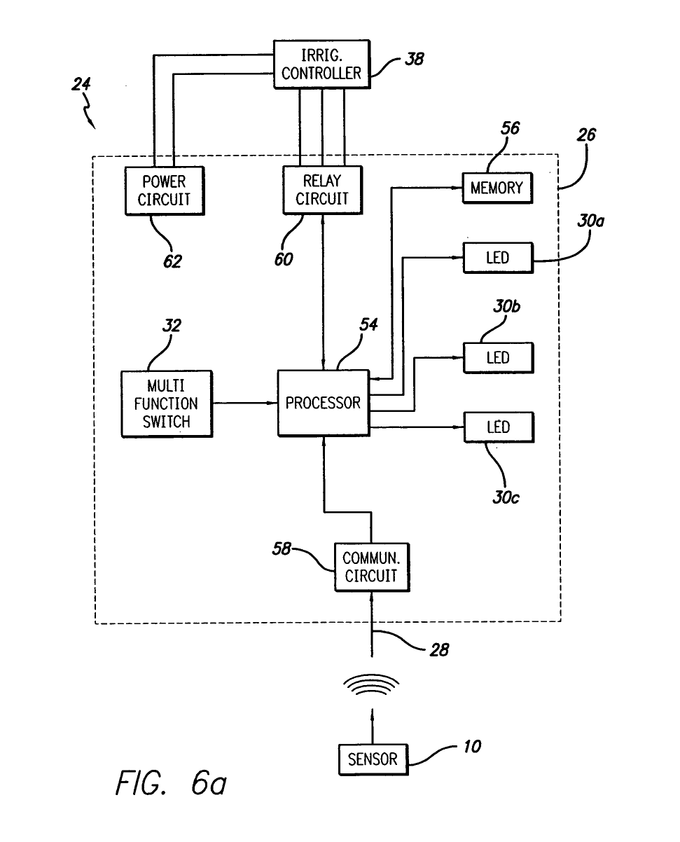

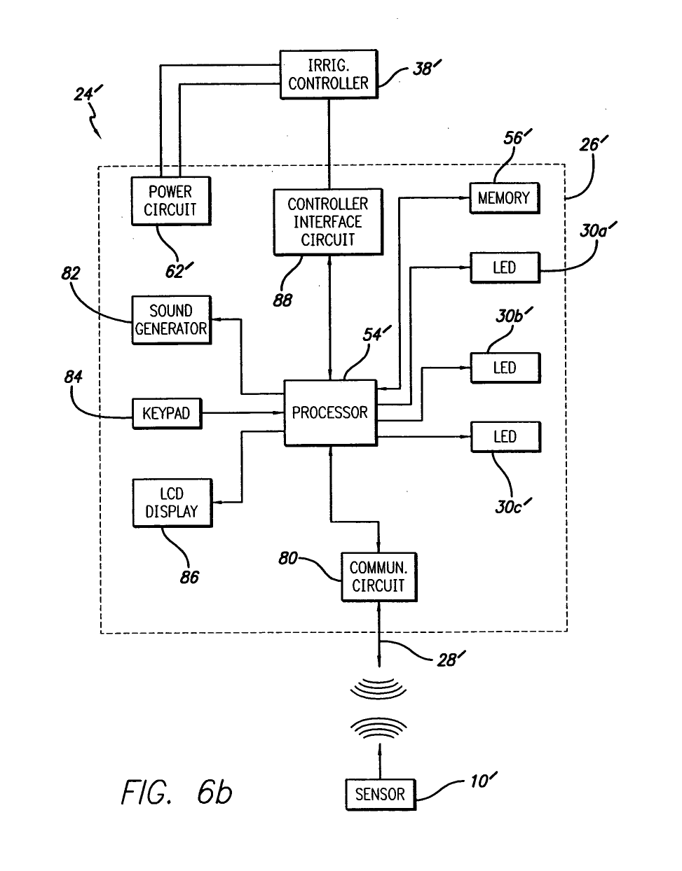

In the embodiment of FIG. 5b, the sensor 10′ includes a communication circuit 76 having a transceiver that is coupled to a processor 42.′ The communication circuit 76 is adapted to both send signals to and receive signals from a controller interface unit 24′ that is coupled to an irrigation controller 38′ (FIG. 6b). Having the ability to receive signals from the interface unit 24′, the sensor 10′ can provide notification to the user of its operation or status at the location of the sensor 10′. Thus the user would not have to travel to the controller interface unit 24′ to observe status indications.

System indicators for providing notification to the user are coupled to the processor 42′ and include an LCD panel or display 74 adapted to display text or images, an LED 72, and a sound generator 70 adapted to emit an alarm, a tone, speech or other audible sounds. The sound generator 70 may be a speaker, a piezoelectric sound device or other sound generating device. User notifications may include notifications of any of the following events: the transmitting of the test signal by the sensor 10′, the receipt of the test signal by the controller interface unit 24′, or a sensor response corresponding to a predetermined value, such as for example an alarm condition associated with precipitation in excess of a given amount or ambient temperature falling below a given level.

A keypad 68 having a plurality of keypad buttons also is coupled to the processor 42′ and permits the user to input a command to initiate a test signal (of reduced signal strength), to clear alarms or indicators, etc. Rather than the keypad 68, alternative embodiments may employ other user input devices, such as for example, one or more manual-operated buttons or switches, a touch screen, a voice-activated device, and a menu structure shown on a display panel that is navigated by a keypad. The water sensor 34′ of the embodiment of FIG. 5b is not combined with a manual test switch, given that testing is initiated via the keypad 68.

The invention disclosed herein is not limited to rain and temperature sensors. As shown in FIG. 5c, other sensors may be employed for wireless communication with an interface unit 24″ for operation of an irrigation system. The sensor unit 10″ of FIG. 5c employs a ground moisture sensor 90a that is coupled to a processor 42″. Ground moisture data or moisture limits can be detected and transmitted via the sensor communication circuit 76′ to the controller interface unit 24″ for the controlling of an irrigation program. Similarly, alternative embodiments of the invention may employ a humidity sensor 90b for detecting the humidity of the surrounding air, a solar radiation sensor 90c for detecting the effects of the sun, a wind speed sensor 90d, or a water flow rate sensor 90e for detecting the rate of water flow through the irrigation system conduits. Alternatively, other sensors for the detection or measurement of other environmental conditions or other irrigation system conditions may be employed as well.

Each of these sensors are adapted to provide a sensor response and may be coupled to the processor 42″ which in turn can cause the sensor communication circuit 76′ to send the appropriate information wirelessly via a signal having a normal signal strength to the controller interface unit 24″ located near the irrigation controller. As before, the keypad can be used as a user input device for entering commands, including the command to transmit a test signal (which will have a reduced signal strength).

Furthermore, one of ordinary skill in the art will appreciate that the integration of a sensor and a communication circuit (including a transmitter or transceiver) may be accomplished in a variety of ways. For example, in one embodiment, a communication circuit with a transceiver may be included within a sensor housing and/or a sensor actuator as part of its internal configuration. In other embodiments, a communication circuit may be externally attached to a sensor and/or a sensor actuator. In further embodiments, a communication circuit may be installed in close proximity to a sensor and/or sensor/actuator such that the communication circuit and sensor (or sensor/actuator) communicate via a wired or wireless connection.

Referring now to FIG. 6a, the interface unit 24 includes a processor 54 that executes programs and controls the interface unit 24. The processor 54 is connected to a memory 56 for storing programs, data and parameters. Although FIG. 6a shows the memory 56 as a separate component, alternative embodiments may use a memory that is integral with the processor 54. The processor 54 is coupled to a communication circuit 58 having a RF receiver that is adapted to receive a RF signal transmitted from the sensor 10. Alternatively, the RF receiver 58 may be replaced with a communication circuit 80 having a RF transceiver (as shown in FIG. 6b), and the signal may be received using the RF transceiver.

After the communication circuit 58 receives the signal from the sensor 10, the processor 54 compares the identity code extracted from the incoming signal with one or more identity codes stored in the memory 56. If there is a match, then the signal is assumed to come from an authorized source or sensor. If the authenticated incoming signal does not contain information indicating that it is a test signal, then the processor 54 actuates a relay circuit 60. (That is, in the case of a circuit having a normally-open relay, the processor will close it. In the case of a circuit having a normally-closed relay, the processor will open it.) The relay circuit 60 is electrically connected to the irrigation controller 38 which then suspends its programmed irrigation schedule in response to the actuation of the relay 60. Alternatively, the relay circuit 60 can be replaced with a controller interface circuit 88 (as shown in FIG. 6b), thus permitting the processor 54 to communicate with or override the irrigation programming of the controller 38′.

While the embodiment of FIG. 6a shows the use of one relay circuit, it will be appreciated by those skilled in the art that alternative embodiments may employ a plurality of relay circuits, each of which is in electrical communication with the processor 54. Thus for example in addition to a relay circuit that is connected to an irrigation controller, one of the additional relay circuits could be connected to an LED indicator and controlled by the processor to activate the LED indicator when a signal is received from a wind sensor. Another of the additional relay circuits could be connected to a different LED indicator and caused to energize or activate that LED indicator when a signal is received from a different sensor on the system, such as for example a water sensor. Yet additional relay circuits could be caused to activate other LED indicators or other displays as a result of signals received from yet other sensors or by other system conditions or user inputs.

Still referring to FIGS. 6a and 6b, if the authenticated incoming signal includes information indicating that it is a test signal, the processor 54 does not actuate the relay circuit 60. Instead, the processor 54 activates a local indicator which, in the embodiment of FIG. 6a, is one of a plurality of LEDs 30a, 30b, 30c mounted on the controller interface unit housing 26 and in electrical communication with the processor 54. The processor 54 causes the LED 30a to remain activated for a predetermined period of time that is sufficient for the user to travel from the remote location of the sensor 10 to the location of the controller interface unit 24 and to observe the LED 30a.

The processor 54 is further coupled to a manual-operated, multi-function switch 32. When the user holds down the switch 32 for a predetermined amount of time, such as for example 3 seconds or more, the processor 54 will place the interface unit 24 in a “program” mode. This mode allows the identity code information from a signal sent by the sensor 10 to be extracted from the signal and stored in the interface unit memory 56 for future reference in authenticating signals during normal operation. Moreover, identity codes from a plurality of sensors may be stored in the memory 56 for irrigations systems having a plurality of sensors.

When the user holds down the switch 32 for another predetermined amount of time, such as for example 2.9 seconds or less, the interface unit 24 is placed in a “bypass” mode. When the switch is held down a second time, the interface unit 24 is returned to its normal mode. Thus these modes are “toggled” by the repeated operation of the switch 32. When in the bypass mode, the processor 54 will not actuate the relay circuit 60 regardless of the nature of any signals that may be received from the sensor 10. Thus the user has the option of bypassing the supervision that the sensor 10 and controller interface unit 24 exercise over the controller 38 thereby allowing the irrigation system controller 38 to perform its programmed irrigation routine regardless of any environmental or irrigation system condition that might be present.

A power circuit 62 is housed within the interface unit housing 26 and provides electrical power for the processor 54, the LEDs 30, the communication circuit 58, the memory 56, the multifunction switch 32 and the relay circuit 60. In the embodiment of FIG. 6a, the irrigation controller 38 supplies power to the power circuit 62 which conditions the incoming power for use by the other interface unit components. In alternative embodiments, any other suitable power supply may be used, such as for example a battery, a fuel cell, a solar panel, or a cable that is connected to some other external power source.

As previously stated, in the embodiment of FIG. 6b, the controller interface circuit 88 replaces the relay circuit. Additionally, the communication circuit 80 has a transceiver that replaces the receiver thereby permitting two-way communication with the sensor 10′. A keypad 84 coupled to a processor 54, replaces the multi-function switch and permits the user to place the controller interface unit 24′ in program mode or override mode, to cause signals to be transmitted to the sensor 10′, to clear alarms or other local indicators, etc. In alternative embodiments, buttons or switches may be used rather than a keypad. Also coupled to the processor 54′ are a LCD display 86 adapted to display text or images and a sound generator 82 adapted to emit an audible alarm, tone, speech or other sounds.

In operation, the user installs the controller interface unit 24 in a location in proximity to the irrigation controller 38. (In alternative embodiments, the interface unit 24 is integral with the irrigation controller 38.) A suitable location is determined for the sensor 10 which is installed at a position that is remote from the controller interface unit 24. In order to test the communication path between the sensor 10 and the interface unit 24, the user presses down on the actuator pin 35 and holds the pin down for a predetermined period of time, which in the embodiment of FIG. 5a is 20 seconds or less. In response to this depressing of the actuator pin 35, the sensor 10 will transmit a test signal at a signal strength that is less than the normal signal strength.

The user then travels to the location of the controller interface unit 24 and observes the LED 30a. If the LED 30a is activated, then the user may have confidence that the communication link between these devices is good and that many types of later-arising interference sources are not likely to break the communication link. After a predetermined amount of time that is sufficient to allow the user to travel from the location of the sensor 10 to the location of the interface unit 24, the interface unit processor 54 will automatically deactivate the LED 30a. On the other hand, if the user observes the interface unit 24 and notes that the LED 30a is not activated, then the user can position the sensor 20 at another location and again initiate a test signal to determine if an acceptable communication path has been found.

With the embodiments of FIGS. 5b and 6b, however, it is not necessary for the user to travel to the controller interface unit 24′ to see if the communication path is working. If the receiver unit 24′ receives the test signal, the controller interface unit communication circuit 80 will send a signal for reception by the sensor communication circuit 76. An appropriate indicator on the sensor 10′, such as the LED 72, the LCD display 74, or the sound generator 70 will notify the user that the test signal was received by the controller interface unit 24′. This indication can be cleared by the user via the keypad 68, or automatically by the processor 42′ after the passage of a predetermined amount of time.

Alternatively, the user can initiate the test signal from the location of the controller interface unit 24′. By pressing the appropriate key on the keypad 84, the user causes the processor 54′ and communication circuit 80 to send a command signal to the sensor 10′. If the sensor unit communication circuit 76 receives the command signal, the sensor unit processor 42′ will cause the communication circuit 76 to send a test signal (at a signal strength that is less than the normal signal strength) to the controller interface unit 24′. If this signal is received by the interface unit 24′, an appropriate indicator on the interface unit, such as the LED 30a′, the LCD display 86, or the sound generator 82, will activate thereby notifying the user that the test signal was received and that the communication path is acceptable. This indication can be cleared by the user via the keypad 84, or automatically by the processor 54, after the passage of a predetermined amount of time.

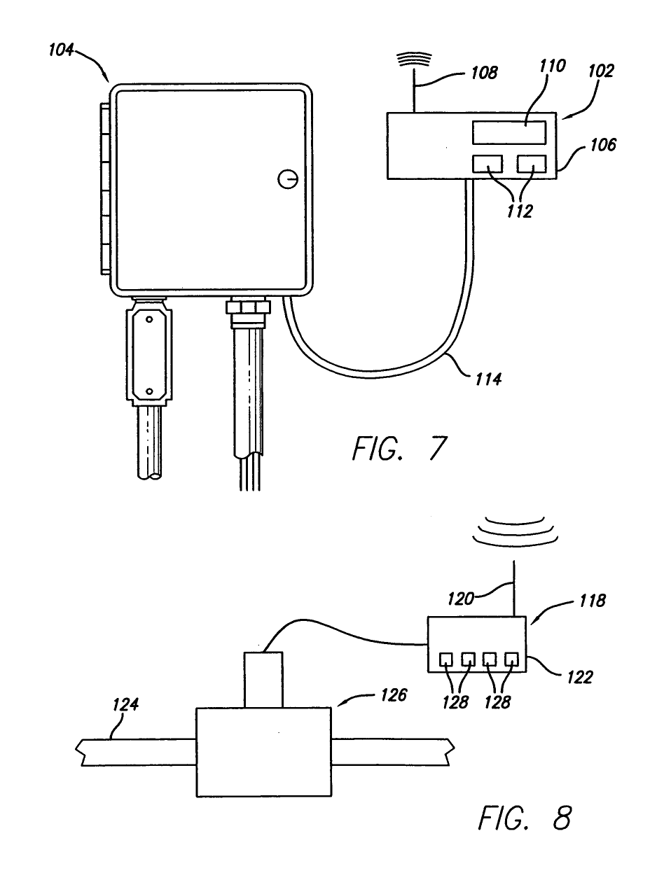

While the embodiments of FIGS. 1-6 involve the use of sensors, alternative embodiments of the invention involve wireless communications with irrigation system pumps or valves. Referring to FIGS. 7-8, the transmitting device is a controller interface unit 102 having a housing 106 adapted for mounting in the vicinity of an irrigation controller 104 and having an external antenna 108 extending from the housing 106. The interface unit 102 has an LCD display 110 mounted on the housing 106 and electrically connected to internal circuitry and a processor (not shown in FIG. 7) located within the housing 106. A plurality of manual-operated switches or buttons 112 extend from the housing 106 and is connected to the processor. The buttons 112 and display 110 are used for scrolling through menu options and commands and for entering the commands.

A cable 114 electrically connects the controller interface unit 102 to the irrigation controller 104 that in turn provides electrical power to the interface unit 102. Additionally the controller 104 provides control signals to the interface unit 102 for the transmission of wireless commands to irrigation system pumps and valves for turning irrigation water flow off and on according to a predetermined irrigation schedule or irrigation programming. While the controller interface unit 102 of the illustrated embodiment is separate from the irrigation controller 104, alternative embodiments may include an interface unit that is integral with an irrigation controller and may be in the form of a permanent or removable module.

When a control signal is sent from the irrigation controller 104 to the controller interface unit 102, the circuitry within the unit 102 causes a communication circuit to emit a radio frequency (RF) signal having a full or normal signal strength via the external antenna 108. The wireless signal is received by a valve interface unit 118 (FIG. 8) having an external antenna 120 extending from an interface unit housing 122 and having internal circuitry (not shown in FIG. 8). The valve interface unit 118 is electrically connected to a solenoid-actuated valve 126 that is installed in-line with a conduit 124 so that the valve can control the passage of water or other fluids through the conduit 124.

Upon receipt of a wireless signal, the internal circuitry within the valve interface unit housing 122 closes a contact (not shown) within the housing 122 which in turn completes an electrical circuit thereby causing the solenoid-actuated valve 126 to actuate. This, in turn, controls the water flow to one or more irrigation system components downstream of the valve. When the valve interface unit 118 receives a wireless signal, the unit circuitry analyzes the signal and determines whether it is authentic and intended for that particular valve interface unit 118 as opposed to another irrigation system component. If the signal is authentic and intended for the valve interface unit 118, the circuitry will close a contact thereby actuating the valve 126.

As previously stated, it is sometimes desirable to test the wireless communication path between the controller interface unit 102 and the valve interface unit 118. For example, this may be desirable during installation of the solenoid valve 126 and valve interface unit 118 at a location that is remote from the interface unit 102. When signal testing is desired, one of the controller interface unit buttons 112 is depressed and then released. This causes the valve interface unit electronics to send a test signal at a strength that is less than the normal signal strength. In the illustrated embodiment, the test signal strength is approximately one half of the normal signal strength. However alternative embodiments of the invention may include any test signal strength that is less than the normal signal strength, or alternatively, a test signal strength that is between about 20% and 80% of the normal signal strength, or alternatively still, a test signal strength that is between about 40% and 60% of the normal signal strength. Moreover, the test signal may include or may be encoded with information indicating that the signal identity is that of a test signal as opposed to a normal signal that is associated with the command to actuate the solenoid valve 126 and with information indicating that the valve interface unit 118 (as opposed to another wireless component) is the intended recipient of the signal.

If the valve interface unit 118 successfully detects the test signal, the unit circuitry will read the information included within the signal to verify that the signal is authentic, is intended for the valve interface unit 118, and is a test signal. If these conditions are met, the valve interface unit 118 will not actuate the contact within the unit housing 122 which in turn will not actuate the solenoid valve 126. Rather, the reception of an authentic test signal will cause the valve interface unit circuitry to activate one or more of the LED's 128 on the valve interface unit housing 122 and maintain the LED in an activated condition for a predetermined period of time. This allows the user adequate time to travel from the location of the controller interface unit 102 to the location of the valve interface unit 118 and observe the LED 128.

If the user sees that the LED is energized, then he or she will know that a communication link was successfully established. Given that a link was established with a test signal having a lower signal strength than that of a normal signal, there may be a higher level of assurance that a normal, full-strength signal will be received despite subsequently-arising interference conditions, such as changing foliage or weather, or the placement of new structures or objects in the communications path.

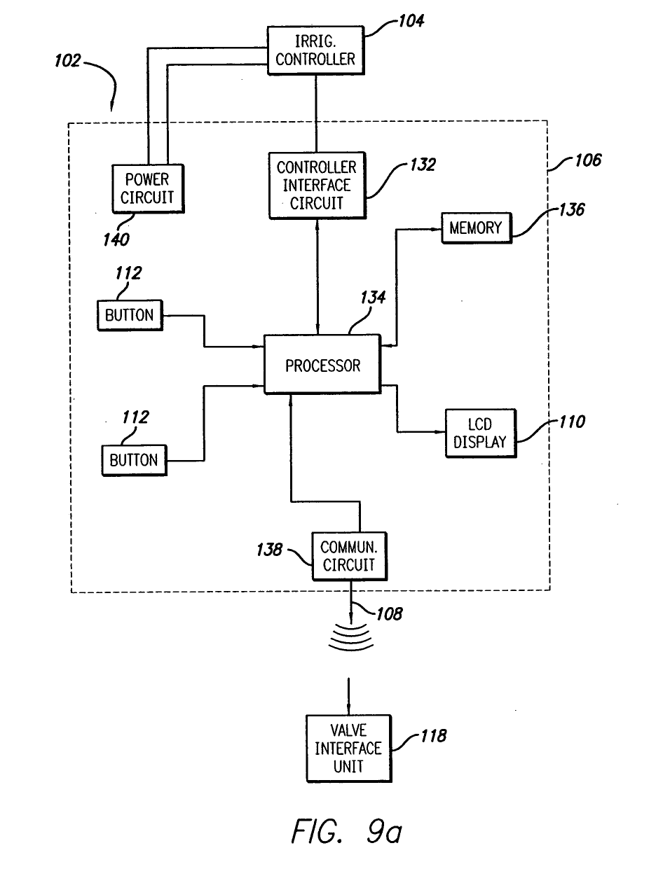

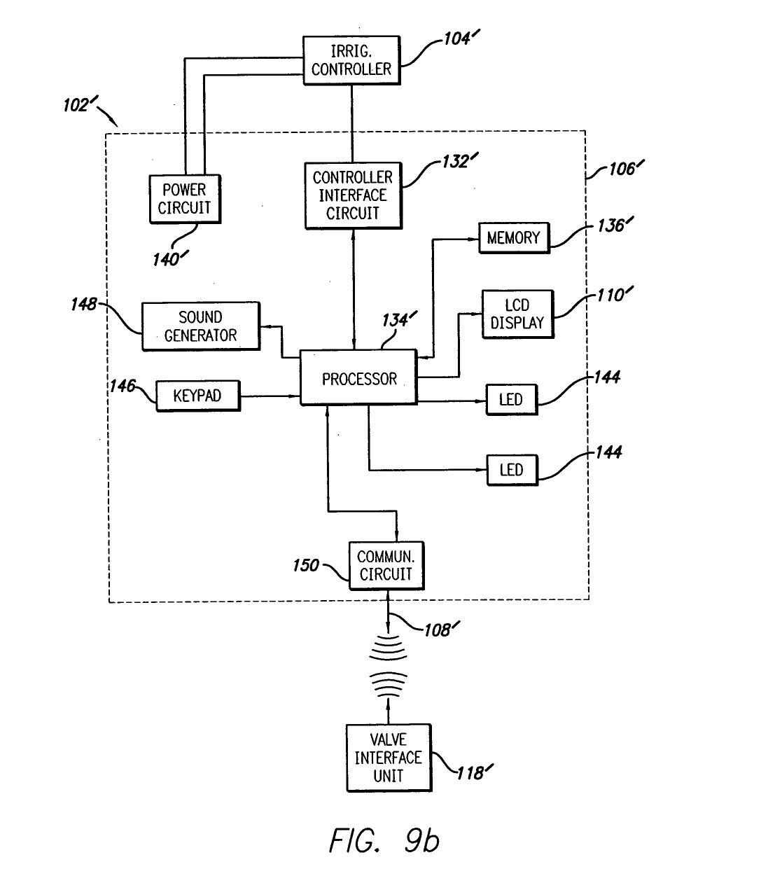

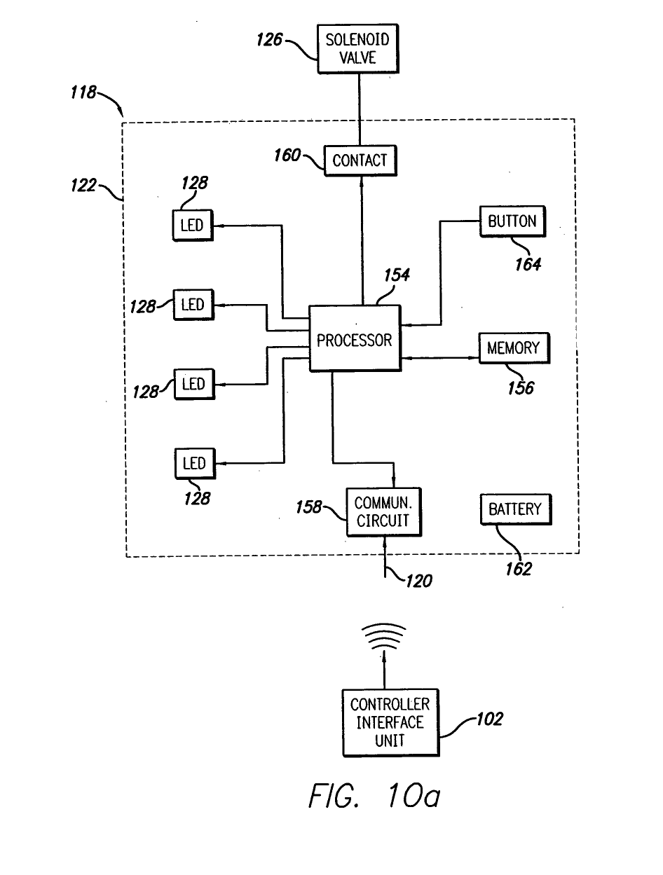

Referring now to FIG. 9a, the controller interface unit 102 includes a controller interface circuit 132 that is coupled to a processor 134 which in turn executes programs and controls the interface unit 102. The processor 134 is also connected to a memory device 136 for storing programs, data and parameters, including identity code or data corresponding to the identity of the controller interface circuit 102. Although FIG. 9a shows the memory 136 as a separate component, alternative embodiments may use a memory that is integral with the processor.

One of ordinary skill in the art will appreciate that the program logic described herein may be implemented in alternative embodiments in hardware, software, firmware, or a combination thereof. The program logic can be implemented in software or firmware that is stored in memory and that is executed by a processor. If implemented in hardware, the logic may be implemented in any one or combination of volatile memory devices (e.g., random access memory (RAM, such as DRAM, SRAM, SDRAM, etc.)) and nonvolatile memory devices (e.g., ROM, EPROM, hard drive, tape, CDROM, etc.).

Memory may incorporate electronic, magnetic, optical, and/or other types of storage media. Memory may also have a distributed architecture, where various components are situated remotely from one another. If implemented in hardware, the logic may be implemented with any or a combination of the following technologies, which are all known in the art: one or more discrete logic circuits for implementing logic functions upon data signals, an application specific integrated circuit (ASIC), a programmable gate array(s) (PGA), a field programmable gate array (FPGA), etc.

When the irrigation controller 104 determines that it is time to actuate the solenoid valve 126 in accordance with an irrigation schedule or programming, it sends a command signal to the controller interface circuit 132 that conditions the signal for receipt and processing by the processor 134. The processor 134 will cause a communication circuit 138 that includes a radio frequency (“RF”) transmitter to transmit a RF signal of full or normal strength that includes or is encoded with information containing the identity code associated with the controller interface unit 102 along with information indicating that the signal is a test signal and that it is intended for the valve interface unit 118. Alternatively, the communication circuit 138 having the RF transmitter may be replaced with a communication circuit 150 having a RF transceiver (as shown in FIG. 9b), and the signal may be transmitted using that communication circuit 150.

On the other hand, if one of the buttons 112 is manually depressed, then the processor 134 causes the communication circuit 138 to transmit a RF signal having a signal strength that is less than normal strength and that includes information containing the identity code of the controller interface unit 102 along with information indicating that the signal is a test signal and that it is intended for the valve interface unit 118. While the illustrated embodiment discloses the transmission and receipt of RF signals, it will be appreciated by those skilled in the art that other wirelessly transmitted signals may be employed, such as for example infrared signals or ultrasonic signals.

Finally, the controller interface unit 102 includes a power circuit 140 which receives electrical power from the irrigation controller 104 and conditions the power for use by the interface unit 102 circuitry. Alternative embodiments however may employ other power sources, such as, for example, a battery, a solar panel, a fuel cell or a power cable that is connected to another external power source. The power circuit 140 provides power to all components of the interface unit circuitry, including the processor 134, the memory 136, the controller interface circuit 132, the buttons 112, the LCD display 110, and the communication circuit 138.

In the embodiment of FIG. 9b, the interface unit 102′ includes a communication circuit 150 having a transceiver that is coupled to a processor 134′. The communication circuit 150 is adapted to both send signals to and receive signals from a valve interface unit 118′. Having the ability to receive signals from the valve interface unit 118′, the controller interface unit 102′ can provide notification to the user of the valve interface unit's 118′ operation or status while the user is at the location of the controller interface unit 102′. Thus the user would not have to travel to the valve interface unit 118′ to observe status indications.

System indicators for providing notification to the user are coupled to the processor 134′ and include an LCD panel or display 110′ adapted to display text or images, a plurality of LEDs 144, and a sound generator 148 adapted to emit an alarm, a tone, speech or other audible sounds. The sound generator 148 may be a speaker, a piezoelectric sound device or other sound generating device. User notifications may include notification of the transmitting of the test signal by the controller interface unit 102′ or the receipt of the test signal by the valve interface unit 118′.

A keypad 146 having a plurality of keypad buttons also is coupled to the processor 134′ and permits the user to input a command to initiate a test signal (of reduced signal strength), to clear alarms or indicators, etc. Rather than the keypad 146, alternative embodiments may employ other user input devices, such as for example, one or more manual-operated buttons or switches, a touch screen, a voice-activated device, and a menu structure shown on a display panel that is navigated by a keypad.

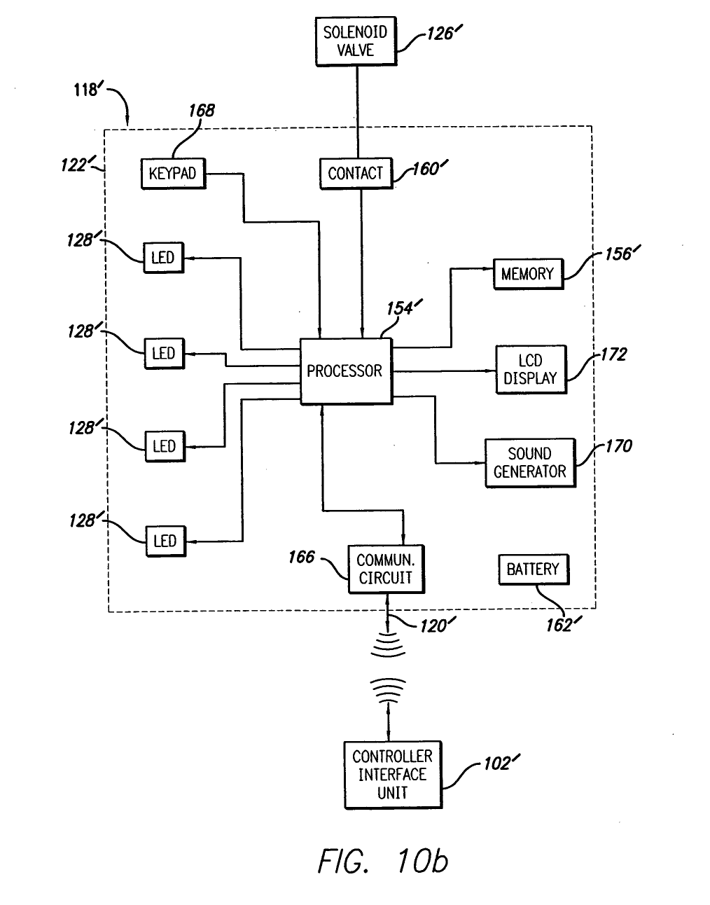

Referring now to FIG. 10a, the valve interface unit 118 includes a processor 154 that executes programs and controls the interface unit 118. The processor 154 is connected to a memory 156 for storing programs, data and parameters. Although FIG. 10a shows the memory 156 as a separate component, alternative embodiments may use a memory that is integral with the processor 154. The processor 154 is coupled to a communication circuit 158 having a RF receiver that is adapted to receive a RF signal transmitted from the controller interface unit 102. Alternatively, the RF receiver 158 may be replaced with a communication circuit 166 having a RF transceiver (as shown in FIG. 10b), and the signal may be received using the RF transceiver.

After the communication circuit 158 receives the signal from the controller interface unit 102, the processor 154 compares the identity code extracted from the incoming signal with one or more identity codes stored in the memory 156. If there is a match, then the signal is assumed to come from an authorized source which in this case, is the controller interface unit 102. Additionally, the processor 154 compares addressee data from the incoming signal to determine whether the signal is intended for the valve interface unit 118 as opposed to another irrigation system component. If the authenticated incoming signal does not contain information indicating that it is a test signal, then the processor 154 actuates a contact 160. The contact 160 is electrically connected to the solenoid valve 126 which then opens or closes, as the case may be, in response to the actuation of the contact 160.

Still referring to FIGS. 10a and 10b, if the authenticated incoming signal includes information indicating that it is a test signal, the processor 154 does not actuate the contact 160. Instead, the processor 154 activates a local indicator which, in the embodiment of FIG. 10a, is one of a plurality of LEDs 128 mounted on the valve interface unit housing 122 and in electrical communication with the processor 154. The processor 154 causes the LED 128 to remain activated for a predetermined period of time that is sufficient for the user to travel from the remote location of the controller interface unit 102 to the location of the valve interface unit 118 and to observe the LED 128.

The processor 154 is further coupled to a manual-operated, switch or button 164. When the user pushes the button 164, the processor 154 will place the valve interface unit 118 in a “program” mode. This mode allows the identity code information from a signal sent by the controller interface unit 102 to be extracted from the signal and stored in the valve interface unit memory 156 for future reference in authenticating signals during normal operation.

A battery 162 is housed within the valve interface unit housing 122 and provides electrical power for the processor 154, the LEDs 128, the communication circuit 158, the memory 156, the button 164 and the contact 160. In alternative embodiments, any other suitable power supply may be used, such as for example a fuel cell, a solar panel, or a cable that is connected to some other external power source.

As previously stated, in the embodiment of FIG. 10b, the communication circuit 166 has a transceiver that replaces the receiver thereby permitting two-way communication with the controller interface unit 102′. A keypad 168 coupled to a processor 154′ permits the user to place the valve interface unit 118′ in program mode or to cause signals to be transmitted to the controller interface unit 102′, to clear alarms or other local indicators, etc. In alternative embodiments, buttons or switches may be used rather than a keypad. Also coupled to the processor 154′ are a LCD display 172 adapted to display text or images and a sound generator 170 adapted to emit an audible alarm, tone, speech or other sounds.

Furthermore, one of ordinary skill in the art will appreciate that the integration of a solenoid valve and a communication circuit (including a transmitter or transceiver) may be accomplished in a variety of ways. For example, in one embodiment, a communication circuit with a transceiver may be included within a solenoid valve housing and/or a solenoid actuator as part of its internal configuration. In other embodiments, a communication circuit may be installed in close proximity to a solenoid valve such that the communication circuit and valve communicate via a wireless connection.

In operation, the user installs the controller interface unit 102 in the vicinity of the irrigation controller 104. (In alternative embodiments, the controller interface unit 102 is integral with the irrigation controller 104.) A suitable location is determined for the valve interface unit 118 which is installed in proximity to the solenoid valve 126 at a position that is remote from the controller interface unit 102. In order to test the communication path between the controller interface unit 102 and the valve interface unit 118, the user presses down on the button 112 on the controller interface unit housing 106 to transmit a test signal at a signal strength that is less than the normal signal strength.

The user then travels to the location of the valve interface unit 118 and observes one of the LEDs 128. If the LED 128 is activated, then the user may have confidence that the communication link between these devices is good and that many types of later-arising interference sources are not likely to break the communication link. After a predetermined amount of time that is sufficient to allow the user to travel from the location of the controller interface unit 102 to the location of the valve interface unit 118, the valve interface unit processor 154 will automatically deactivate the LED 128. On the other hand, if the user observes that the LED 128 is not activated, then the user can position the valve interface unit 118 at another location (which may require using a greater length of cable or wire for connecting the valve interface unit 118 with the solenoid valve 126) and again initiate a test signal to determine if an acceptable communication path has been found.

With the embodiments of FIGS. 9b and 10b, however, it is not necessary for the user to travel to the valve interface unit 118′ to see if the communication path is working. If the valve interface unit 118′ receives the test signal, the valve interface unit communication circuit 166 will send a signal for reception by the controller interface unit communication circuit 150. An appropriate indicator on the controller interface unit 102′, such as the LED 144, the LCD display 110′, or the sound generator 148 will notify the user that the test signal was received by the valve interface unit 118′. This indication can be cleared by the user via the keypad 146, or automatically by the processor 134′ after the passage of a predetermined amount of time.

Alternatively, the user can initiate the test signal from the location of the valve interface unit 118.′ By pressing the appropriate key on the keypad 168, the user causes the processor 154′ and communication circuit 166 to send a command signal to the controller interface unit 102′. If the controller interface unit communication circuit 150 receives the command signal, the controller interface unit processor 134′ will cause the communication circuit 150 to send a test signal (at a signal strength that is less than the normal signal strength) to the valve interface unit 118′. If this signal is received, an appropriate indicator on the valve interface unit 118′, such as the LED 128′, the LCD display 172, or the sound generator 170, will activate thereby notifying the user that the test signal was received and that the communication path is acceptable. This indication can be cleared by the user via the keypad 168, or automatically by the processor 154′ after the passage of a predetermined amount of time.

Thus there is disclosed a wireless system that includes one or more transmitting devices and one or more receiving devices. During installation of the system, the user can activate a test signal to be sent from the transmitting device to the receiving device in order to determine if the specific installation location will result in a reliable communication path when various types of interference are encountered in the future. According to one embodiment of the invention, the user initiates a test signal by depressing a pin or button mounted on the transmitting device. This will cause the transmitting device to send a test signal at about half of the normal transmitting signal strength. If the receiving device successfully receives the signal, the user is notified by LEDs or other indicators located either on the receiving or transmitting device.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

1. A first apparatus for use with an irrigation system comprising:
a processor;
a sensor coupled to the processor and adapted to provide a sensor response; and
a communication circuit coupled to the processor;
wherein the processor is adapted to:
cause the communication circuit to transmit a first signal in response to the sensor response, the first signal having a first signal strength; and
cause the communication circuit to transmit a second signal having a second signal strength, wherein the second signal strength is less than the first signal strength.

2. The first apparatus of claim 1 wherein the communication circuit includes one of a transmitter and a transceiver.

3. The first apparatus of claim 1 wherein the sensor is comprised of an electrical contact adapted to be actuated and wherein the sensor response is the actuation of the electrical contact.

4. The first apparatus of claim 1 wherein the sensor is comprised of an electrical contact adapted to be actuated and wherein the sensor response is the actuation of the electrical contact, the first apparatus further comprising a user input device for inputting a command, said input device being adapted to actuate the electrical contact.

5. The first apparatus of claim 4 wherein the electrical contact has a first position and a second position, wherein the electrical contact is moved from the first position to the second position when the electrical contact is actuated, and wherein the processor causes the communication circuit to transmit the second signal when the electrical contact is in the second position for a predetermined period of time.

6. The first apparatus of claim 1 further comprising a user input device for inputting a command, said input device being coupled to the processor, wherein the second signal is transmitted in response to the command from the input device.

7. The first apparatus of claim 6 wherein the user input device is one of a button, a touch screen, a voice-activated device, and a menu structure shown on a display panel that is navigated by a keypad.

8. The first apparatus of claim 1 wherein the second signal strength is between 20% and 80% of the first signal strength.

9. The first apparatus of claim 1 wherein the second signal strength is between 40% and 60% of the first signal strength.

10. The first apparatus of claim 1 wherein the first apparatus is for use with a second apparatus that is adapted to receive the first and second signals, the first apparatus further comprising an indicator coupled to the processor and adapted to provide a notification of at least one event of the group consisting of: the transmitting of the second signal by the communication circuit, the receipt of the second signal by the second apparatus, and the sensor response corresponding to a predetermined value.

11. The first apparatus of claim 10 wherein the indicator includes one of a sound generation device, a panel adapted to display text, and a LED.

12. The first apparatus of claim 1 wherein the sensor is a water sensor.

13. The first apparatus of claim 1 wherein the sensor is one of a temperature sensor, a humidity sensor, a ground moisture sensor, a solar radiation sensor, a wind speed sensor, and a water flow rate sensor.

14. The first apparatus of claim 1 wherein the first apparatus has an identity, the first apparatus further comprising a memory coupled to the processor, said memory being adapted to store an identity code corresponding to the first apparatus identity, and wherein the first signal includes the identity code.

15. The first apparatus of claim 1 wherein the second signal has an identity and wherein the second signal includes information corresponding to the identity.

16. A first apparatus for use with a second apparatus and for use with an irrigation system having an irrigation system controller adapted to operate an irrigation program, said second apparatus having a sensor adapted to provide a sensor response, said second apparatus being adapted to transmit a first signal in response to the sensor response and to transmit a second signal, said first signal having a first signal strength and said second signal having a second signal strength that is less than the first signal strength, the first apparatus comprising:
a processor coupled to the irrigation system controller;
an indicator coupled to the processor; and
a communication circuit coupled to the processor and adapted to receive the first signal and the second signal;
wherein the processor is adapted to:
cause the irrigation system controller to terminate the irrigation program when the communication circuit receives the first signal; and
cause the indicator to activate when the communication circuit receives the second signal.

17. The first apparatus of claim 16 wherein the communication circuit includes one of a transmitter and a transceiver.

18. The first apparatus of claim 16 wherein the second signal strength is between 20% and 80% of the first signal strength.

19. The first apparatus of claim 16 wherein the second signal strength is between 40% and 60% of the first signal strength.

20. The first apparatus of claim 16 further comprising a relay circuit coupled to the processor and to the irrigation system controller wherein the processor is adapted to cause the irrigation system controller to terminate the irrigation program by actuating the relay circuit when the communication circuit receives the first signal.

21. The first apparatus of claim 16 wherein the indicator comprises one of a sound generation device, a panel adapted to display text, and a LED.

22. The first apparatus of claim 16 wherein the sensor is a water sensor.

23. The first apparatus of claim 16 wherein the sensor is one of a temperature sensor, a humidity sensor, a ground moisture sensor, a solar radiation sensor, a wind speed sensor, and a water flow rate sensor.

24. The first apparatus of claim 16 wherein the second apparatus has an identity, the first apparatus further comprising a memory coupled to the processor, said memory being adapted to store an identity code corresponding to the second apparatus identity, and wherein the first signal includes the identity code.

25. The first apparatus of claim 16 wherein the second signal has an identity and wherein the second signal includes information corresponding to the identity.

26. A method of testing a communication path between a first apparatus and a second apparatus, said first and second apparatuses being for use in an irrigation system, said first apparatus having a sensor adapted to provide a sensor response, the method comprising:
placing the first apparatus at a location that is spaced apart from the second apparatus;
inputting a command with a user input device; and
transmitting a first signal with a communication circuit in response to the command, said first signal having a first signal strength, said communication circuit being adapted to transmit a second signal in response to the sensor response, said second signal having a greater signal strength than the first signal strength.

27. The method of claim 26 wherein the communication circuit includes one of a transmitter and a transceiver.

28. The method of claim 26 wherein the sensor is comprised of an electrical contact adapted to be actuated and wherein the sensor response is the actuation of the electrical contact.

29. The method of claim 26 wherein the sensor is comprised of an electrical contact adapted to be actuated and wherein the sensor response is the actuation of the electrical contact, and wherein the user input device is adapted to actuate the electrical contact.

30. The method of claim 26 wherein the user input device is one of a button, a touch screen, a voice-activated device, and a menu structure shown on a display panel that is navigated by a keypad.

31. The method of claim 26 wherein the first signal strength is between 20% and 80% of the second signal strength.

32. The method of claim 26 wherein the first signal strength is between 40% and 60% of the second signal strength.

33. The method of claim 26 wherein the sensor is a water sensor.

34. The method of claim 26 wherein the sensor is one of a temperature sensor, a humidity sensor, a ground moisture sensor, a solar radiation sensor, a wind speed sensor, and a water flow rate sensor.

35. A first apparatus for use with an irrigation system comprising:
means for providing a first response as a function of an environmental condition;
means for transmitting a first signal having a first signal strength and a second signal having a second signal strength, wherein the second signal strength is less than the first signal strength;
a processor coupled to the providing means and the transmitting means; and
a program logic executed by the processor, comprising:
means for causing the transmitting means to transmit the first signal in response to the first response; and
means for causing the transmitting means to transmit the second signal.

36. The first apparatus of claim 35 further comprising means for manually inputting a command,
wherein the processor is coupled to the inputting means; and
wherein the means for causing the transmitting means to transmit the second signal is in response to the command.

37. The first apparatus of claim 36 wherein the inputting means has a first position and a second position,
wherein the inputting means is moved from the first position to the second position when the command is inputted, and
wherein the means for causing the transmitting means to transmit the second signal transmits the second signal when the inputting means is in the second position for a predetermined period of time.

38. The first apparatus of claim 35 wherein the second signal strength is between 20% and 80% of the first signal strength.

39. The first apparatus of claim 35 wherein the second signal strength is between 40% and 60% of the first signal strength.

40. The first apparatus of claim 35 wherein the first apparatus is for use by a user and for use with a second apparatus that is adapted to receive the first and second signals, the first apparatus further comprising means for notifying the user,
wherein the processor is coupled to the notifying means; and
wherein the program logic further comprises:
means for causing the notifying means to notify the user of one event of the group consisting of: the transmitting of the second signal by the transmitting means, the receipt of the second signal by the second apparatus, and the first response corresponding to a predetermined value.

41. The first apparatus of claim 35 wherein the first apparatus has an identity, the first apparatus further comprising means for storing identity data corresponding to the first apparatus identity,
wherein said storing means is coupled to the processor; and
wherein the first signal includes the identity data.

42. The first apparatus of claim 35 wherein the second signal has a signal identity and wherein the second signal includes data corresponding to the signal identity.

43. A first apparatus for use with an irrigation system having an irrigation controller adapted to provide a control signal, the first apparatus comprising:
a processor coupled to the irrigation controller and adapted to process the control signal; and
a communication circuit coupled to the processor;
wherein the processor is adapted to:
cause the communication circuit to transmit a first signal in response to the control signal, the first signal having a first signal strength; and
cause the communication circuit to transmit a second signal having a second signal strength, wherein the second signal strength is less than the first signal strength.

44. The first apparatus of claim 43 wherein the communication circuit includes one of a transmitter and a transceiver.

45. The first apparatus of claim 43 further comprising a user input device for inputting a command, said user input device being coupled to the processor, wherein the second signal is transmitted in response to the command from the user input device.

46. The first apparatus of claim 45 wherein the user input device is one of a button, a touch screen, a voice-activated device, and a menu structure shown on a display panel that is navigated by a keypad.

47. The first apparatus of claim 43 wherein the second signal strength is between 20% and 80% of the first signal strength.

48. The first apparatus of claim 43 wherein the second signal strength is between 40% and 60% of the first signal strength.

49. The first apparatus of claim 43 wherein the first apparatus is for use with a second apparatus that is adapted to receive the first and second signals, the first apparatus further comprising an indicator coupled to the processor and adapted to provide a notification of at least one event of the group consisting of: the transmitting of the second signal by the communication circuit and the receipt of the second signal by the second apparatus.

50. The first apparatus of claim 49 wherein the indicator includes one of a sound generation device, a panel adapted to display text, and a LED.

51. The first apparatus of claim 43 wherein the first apparatus has an identity, the first apparatus further comprising a memory coupled to the processor, said memory being adapted to store an identity code corresponding to the first apparatus identity, and wherein the first signal includes the identity code.

52. The first apparatus of claim 43 wherein the second signal has an identity and wherein the second signal includes information corresponding to the identity.

53. A first apparatus for use with a second apparatus and for use with an irrigation system having an irrigation controller adapted to provide a control signal for the actuation of a valve, the second apparatus being coupled to the irrigation controller, the second apparatus being adapted to transmit a first signal having a first signal strength in response to the control signal and adapted to transmit a second signal having a second signal strength that is less than the first signal strength, the first apparatus comprising:
a processor coupled to the valve;
an indicator coupled to the processor; and
a communication circuit coupled to the processor and adapted to receive the first signal and the second signal;
wherein the processor is adapted to:
cause the valve to actuate when the communication circuit receives the first signal; and
cause the indicator to activate when the communication circuit receives the second signal.

54. The first apparatus of claim 53 wherein the communication circuit includes one of a transmitter and a transceiver.

55. The first apparatus of claim 53 wherein the second signal strength is between 20% and 80% of the first signal strength.

56. The first apparatus of claim 53 wherein the second signal strength is between 40% and 60% of the first signal strength.

57. The first apparatus of claim 53 further comprising a contact coupled to the processor and coupled to the valve wherein the processor is adapted to cause the valve to actuate by actuating the contact when the communication circuit receives the first signal.

58. The first apparatus of claim 53 wherein the indicator is comprised of one of a sound generation device, a panel adapted to display text, and a LED.

59. The first apparatus of claim 53 wherein the second apparatus has an identity, the first apparatus further comprising a memory coupled to the processor, said memory being adapted to store an identity code corresponding to the second apparatus identity, and wherein the first signal includes the identity code.

60. The first apparatus of claim 53 wherein the second signal has an identity and wherein the second signal includes information corresponding to the identity.

61. A method of testing a communication path between a first apparatus and a second apparatus, said first and second apparatuses being for use in an irrigation system having an irrigation controller adapted to provide a control signal, the method comprising:
placing the first apparatus at a location that is spaced apart from the second apparatus;
inputting a user command with a user input device; and
transmitting a first signal with a communication circuit in response to the user command, said first signal having a first signal strength, said communication circuit being adapted to transmit a second signal in response to the control signal, said second signal having a greater signal strength than the first signal strength.

62. The method of claim 61 wherein the communication circuit includes one of a transmitter and a transceiver.

63. The method of claim 61 wherein the user input device is one of a button, a touch screen, a voice-activated device, and a menu structure shown on a display panel that is navigated by a keypad.

64. The method of claim 61 wherein the first signal strength is between 20% and 80% of the second signal strength.

65. The method of claim 61 wherein the first signal strength is between 40% and 60% of the second signal strength.

66. The method of claim 61 wherein the second apparatus is in wired electrical communication with a solenoid-actuated valve.

67. A first apparatus for use with an irrigation system having an irrigation controller adapted to provide a control signal, said first apparatus comprising:
a processor coupled to the irrigation controller and adapted to process the control signal;
means for transmitting a first signal having a first signal strength and a second signal having a second signal strength, wherein the second signal strength is less than the first signal strength;
wherein the processor is coupled to the transmitting means; and
a program logic executed by the processor, comprising:
means for causing the transmitting means to transmit the first signal in response to the control signal; and
means for causing the transmitting means to transmit the second signal.

68. The first apparatus of claim 67 further comprising means for manually inputting a user command,
wherein the processor is coupled to the inputting means; and
wherein the means for causing the transmitting means to transmit the second signal is in response to the user command.

69. The first apparatus of claim 67 wherein the second signal strength is between 20% and 80% of the first signal strength.

70. The first apparatus of claim 67 wherein the second signal strength is between 40% and 60% of the first signal strength.

71. The first apparatus of claim 67 wherein the first apparatus is for use by a user and for use with a second apparatus that is adapted to receive the first and second signals, the first apparatus further comprising means for notifying the user,
wherein the processor is coupled to the notifying means; and
wherein the program logic further comprises:
means for causing the notifying means to notify the user of one event of the group consisting of: the transmitting of the second signal by the transmitting means and the receipt of the second signal by the second apparatus.

72. The first apparatus of claim 67 wherein the first apparatus has an identity, the first apparatus further comprising means for storing identity data corresponding to the first apparatus identity,
wherein said storing means is coupled to the processor; and
wherein the first signal includes the identity data.

73. The first apparatus of claim 67 wherein the second signal has a signal identity and wherein the second signal includes data corresponding to the signal identity.
